(19) United States
(12) Patent Application Publication
(10) Pub. No.: US 2026/0264110 A1
(43) Pub. Date: Sep. 10, 2026

(54) ULTRASONIC DEVICE, CONTROL DEVICE, PROGRAM, AND SYSTEM

(71) Applicant: THE UNIVERSITY OF TOKYO, Tokyo (JP)

(72) Inventors: Takaaki KAMIGAKI, Tokyo (JP); Hiroyuki SHINODA, Tokyo (JP); Shun SUZUKI, Tokyo (JP); Yuki NINOMIYA, Tokyo (JP); Tao MORISAKI, Tokyo (JP); Gakuto ARAKAWA, Tokyo (JP); Atsushi MATSUBAYASHI, Tokyo (JP); Kentaro ARIGA, Tokyo (JP)

(21) Appl. No.: 19/165,365

(22) PCT Filed: Feb. 27, 2024
(86) PCT No.: PCT/JP2024/006977

§ 371 Date: Sep. 15, 2025

(30) Foreign Application Priority Data
Mar. 24, 2023 (JP) 2023-048338

(51) Int. Cl. B06B 1/06; B06B 1/02

(52) U.S. Cl. CPC B06B 1/06; B06B 1/0207

(57) ABSTRACT

An ultrasonic device is provided. This ultrasonic device comprises a vibration film, a tension maintaining means, and a plurality of elements. The vibration film is disposed with tension applied thereto. The tension maintaining means supports the vibration film and is not deformed by the restoring force of the vibration film. The elements are periodically arranged on the vibration film, and are each provided with a first electrode and a second electrode. The first electrode is disposed so as to adjoin the vibration film. The second electrode is disposed at a position facing the first electrode.

### CROSS REFERENCE TO RELATED APPLICATIONS

This application is a 371 U.S. National Phase of International Application No. PCT/JP2024/006977, filed on Feb. 27, 2024, which claims priority to Japanese Patent Application No. 2023-048338, filed on Mar. 24, 2023. The entire disclosures of the above applications are incorporated herein by reference.

### BACKGROUND

### Technical Field

The present invention relates to an ultrasound device, a control device, and a program, and a system.

### Related Art

An airborne ultrasound phased array (AUPA) that is capable of generating strong airborne ultrasound includes an array of transducers that are capable of generating ultrasound at a freely determined intensity and phase.

An ultrasound device for providing a sheet-like airborne ultrasound device that has a high output and high efficiency and that is capable of being transparent is proposed (for example, see International Publication No. 2022/149486 (Patent Document 1)).

A wide range of applications of the ultrasound device such as the levitation of a fine or light object, airborne haptics, and control of airflow are considered. For the applications, the ultrasound device is preferably manufactured at low costs.

In view of the circumstances described above, the present invention provides an ultrasound device, a control device, a program, and a system that can be manufactured at low costs.

### SUMMARY

According to an aspect of the present invention, an ultrasound device is provided.

The ultrasound device includes a vibrating membrane, a tension-maintaining means, and multiple elements.

The vibrating membrane is provided under tension.

The tension-maintaining means supports the vibrating membrane and does not deform due to restoring force of the vibrating membrane. The elements are periodically provided on the vibrating membrane, and each of the elements includes a first electrode and a second electrode. The first electrode is in contact with the vibrating membrane.

The second electrode faces the first electrode.

An aspect of the present invention enables a circuit to be greatly simplified and enables low-cost manufacturing.

### BRIEF DESCRIPTION OF THE DRAWINGS

FIG. 1 illustrates an example in which a vibrating membrane is provided.

FIG. 2 is a diagram for describing an example of a tension-maintaining means.

FIG. 3 illustrates an example in which elements are arranged.

FIG. 4 illustrates an example of the structure of an element.

FIG. 5 illustrates an example of the structure of the element.

FIG. 6 illustrates an example of the structure of the element.

FIG. 7 illustrates an example of the structure of the element.

FIG. 8 illustrates an example of the structure of the element.

FIG. 9 illustrates an example in which an ultrasound device that emits ultrasound is disposed.

FIG. 10 illustrates an example of the structure of an ultrasound device 11.

FIG. 11 illustrates an example in which an ultrasound device that reflects ultrasound is disposed.

FIG. 12 illustrates an example of the structure of an ultrasound device 13.

FIG. 13 illustrates an example in which electrodes are arranged.

FIG. 14 illustrates an example of the structure of each of elements 20.

FIG. 15 is a diagram for describing a method of fixing spacers SP and a vibrating membrane 150 to each other.

FIG. 16 illustrates an example of the structure of an element 520.

FIG. 17 is a diagram for describing the operation of each element 20.

FIG. 18 is a diagram for describing the control of each element 20.

FIG. 19 illustrates a combination of a voltage that is applied to each element 20 and the state of the element at this time.

FIG. 20 illustrates the flow of pattern generation.

FIG. 21 illustrates the flow of pattern generation.

FIG. 22 illustrates the flow of pattern generation.

FIG. 23 illustrates an example in which an alternating voltage is applied.

FIG. 24 illustrates sound pressure distribution in the result of a simulation.

FIG. 25 illustrates the sound pressure distribution in the result of a simulation.

FIG. 26 illustrates the sound pressure distribution in the result of a simulation.

FIG. 27 illustrates the sound pressure distribution in the result of a simulation.

FIG. 28 illustrates the sound pressure distribution in the result of a simulation.

FIG. 29 illustrates the sound pressure distribution in the result of a simulation.

FIG. 30 illustrates the sound pressure distribution in the result of a simulation.

FIG. 31 illustrates an example of the structure of a system that includes an ultrasound device.

FIG. 32 illustrates an example of the structure of an information-processing apparatus 1001.

FIG. 33 is a block diagram illustrating a functional structure of the information-processing apparatus 1001.

### DETAILED DESCRIPTION

An embodiment of the present disclosure will hereinafter be described with reference to the drawings.

Various features described according to the embodiment below can be combined with each other.

A program for providing software described according to the present embodiment may be provided as a non-transitory computer-readable medium, may be provided as a program that can be downloaded from an external server, or may be provided such that an external computer starts up the program, and the function thereof may be fulfilled by using a client terminal (so-called cloud computing).

According to the present embodiment, for example, a “portion” or a “unit” can include a combination of a hardware resource that is operated by a circuit in a broad sense and information processing of software that is specifically provided by the hardware resource.

According to the present embodiment, various kinds of information are used, and the information is represented by, for example, a physical value of a signal value that represents voltage or current, the magnitude of a signal value that is expressed as a binary bit set consisting of 0 or 1, or quantum superposition (a so-called quantum bit), and the circuit in the broad sense enables communication and calculation.

The circuit in the broad sense is provided by appropriately combining at least a circuit, a circuitry, a processor, a memory, and so on.

That is, an application specific integrated circuit (ASIC), and programmable logic devices (such as a simple programmable logic device (SPLD), a complex programmable logic device (CPLD), and a field programmable gate array (FPGA)), for example, are included.

### 1. Summary

A summary of an ultrasound device will be described.

The ultrasound device includes a vibrating membrane, a tension-maintaining means, and multiple elements.

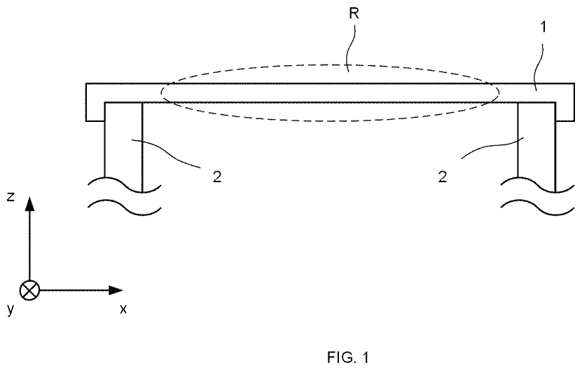

The vibrating membrane will now be described. FIG. 1 illustrates an example in which the vibrating membrane is provided. A vibrating membrane 1 illustrated in the figure is under tension and is provided on a flange 2. The flange 2 supports the vibrating membrane 1 and can be used as the tension-maintaining means. In the case where the flange 2 is used as the tension-maintaining means, the flange 2 needs to have strength so as not to deform due to the restoring force of the vibrating membrane 1. The elements described later are disposed in a region R of the vibrating membrane 1 that is surrounded by the flange 2.

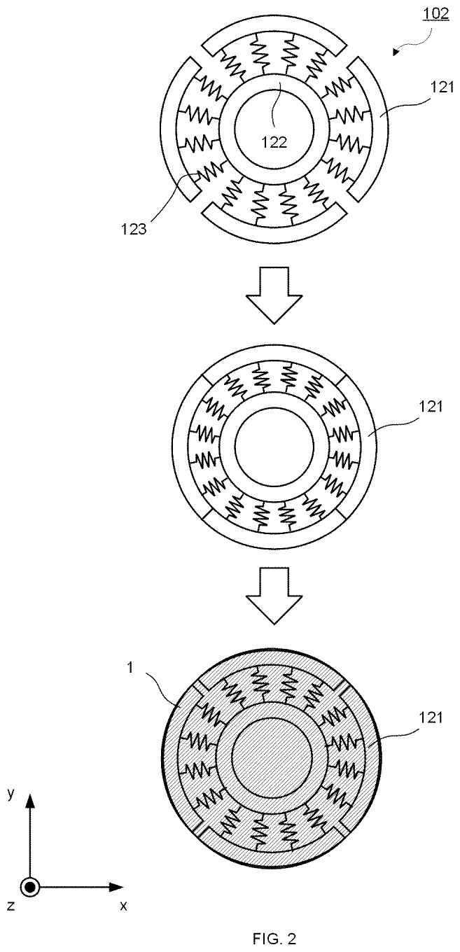

Another example of the tension-maintaining means will now be described. FIG. 2 is a diagram for describing the example of the tension-maintaining means. A tension-maintaining means 102 illustrated in the figure includes an outer flange 121, an inner flange 122, and an elastic body 123. The outer flange 121 can be pressed toward the inner flange 122, and the elastic body 123 deforms when the outer flange 121 is pressed. When pressing force is released with the outer flange 121 pressed, the outer flange 121 returns to the original position due to the restoring force of the elastic body 123. Accordingly, the vibrating membrane 1 under tension is provided on the outer flange 121 with the outer flange 121 pressed, and consequently, the tension that is applied to the vibrating membrane 1 can be maintained by the elastic body 123. The tension is maintained, for example, in a manner in which the restoring force of the vibrating membrane 1 is reduced due to the deformation of the elastic body 123. The vibrating membrane 1 is provided on a surface of the tension-maintaining means 102 at a larger z-axis coordinate so as to be parallel with an xy plane in the figure.

The tension that is applied to the vibrating membrane 1 is set such that the spring constant of membrane elasticity that is derived from the tension is sufficiently higher than the spring constant (including nonlinearity) that is derived from the rigidity of the vibrating membrane 1, and consequently, preferred displacement can be ensured. For this reason, the material and size of the membrane are preferably determined such that the spring constant of the membrane elasticity that is derived from the tension is sufficiently higher than the spring constant that is derived from the rigidity of the membrane.

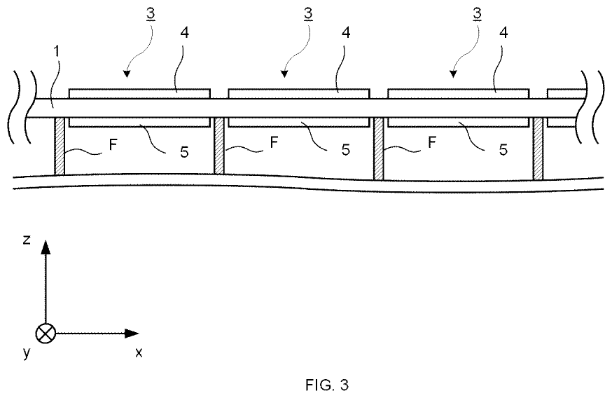

An example in which elements are arranged will now be described. FIG. 3 illustrates the example in which the elements are arranged. As illustrated in the figure, elements 3 are periodically provided on the vibrating membrane 1. To be periodically provided means that elements that have the same shape are literally provided at a regular interval in some cases and that elements that have similar shapes are repeatedly provided with the interval slightly changing in other cases. In other cases, a resonate frequency is kept constant, and the multiple elements 3 that have different shapes are provided in line. In other cases, the shapes are determined such that the resonate frequency changes depending on the elements. The elements 3 are provided in the region R illustrated in FIG. 1. Each of the elements 3 includes an electrode 4 that corresponds to a first electrode and an electrode 5 that corresponds to a second electrode. The electrode 4 is in contact with the vibrating membrane 1, and the electrode 5 faces the electrode 4. The elements 3 are provided on a substrate, and fixed portions F of the substrate to the vibrating membrane 1 are periodically fixed to the vibrating membrane 1. With this structure, the vibrating membrane 1 has a region that is surrounded by the fixed portions F of the substrate and that resonates at a predetermined frequency. At this time, the tension may be set such that the resonate frequency is equal to the frequency of ultrasound to be used. In order to sufficiently increase the vibration displacement of the membrane in the region that is surrounded by the fixed portions F, the region is preferably enlarged as much as possible. For this reason, sufficiently strong tension is preferably applied such that a high resonate frequency is maintained in a large region unless the membrane is broken. As for resonance at this time, a basic vibration mode (a lowest order mode) in which the entire membrane vibrates at the same phase is preferably used.

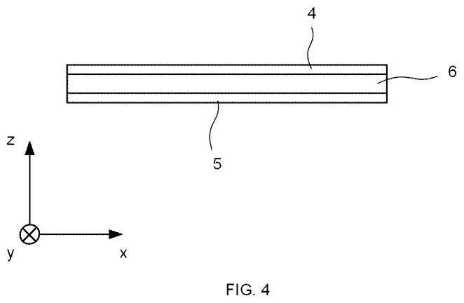

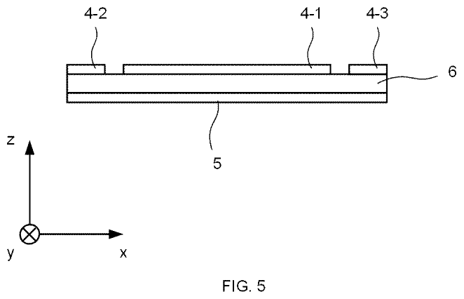

Examples of the structure of each element 3 will now be described. FIG. 4 to FIG. 8 illustrate the examples of the structure of the element. In the example illustrated in FIG. 4, the electrode 4 that corresponds to the first electrode and the electrode 5 that corresponds to the second electrode are in contact with a vibrating membrane 6. The vibrating membrane 6 corresponds to the vibrating membrane 1 described above and is composed of a piezoelectric material. In the case where the electrode 4 is provided on a front surface of the vibrating membrane 6, the electrode 5 is provided on a back surface of the vibrating membrane 6. In the case where the electrode 5 is provided on the front surface of the vibrating membrane 6, the electrode 4 is provided on the back surface of the vibrating membrane 6. According to this aspect, in the case where a voltage is applied between the electrode 4 and the electrode 5, the vibrating membrane 6 expands and contracts in an x-axis direction in the figure. As a result, a vibration is produced such that the direction of amplitude is a z-axis direction in the figure. A material such as silicon, polyimide, or aramid other than the piezoelectric material may be on a surface of the electrode 5 that is not in contact with the vibrating membrane 6, that is, a surface at a smaller z-axis coordinate. This structure is referred to as a unimorph structure. The electrode 4 does not need to cover the entire surface of the vibrating membrane 6 but may be divided into an electrode 4-1, an electrode 4-2, and an electrode 4-3 as illustrated in FIG. 5, or the vibrating membrane 6 may be partly covered such that the electrode 4-2 and the electrode 4-3 are omitted (are not used).

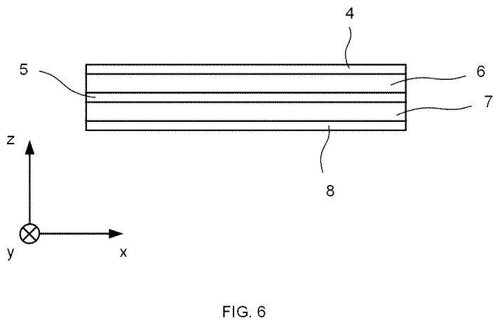

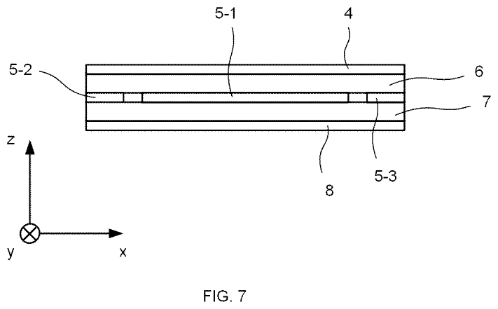

In an example illustrated in FIG. 6, the electrode 4 that corresponds to the first electrode and the electrode 5 that corresponds to the second electrode are in contact with the vibrating membrane 6, and the electrode 5 that corresponds to the second electrode and an electrode 8 that corresponds to the first electrode are in contact with a vibrating membrane 7. The vibrating membrane 6 and the vibrating membrane 7 are composed of a piezoelectric material that has elastic properties opposite with respect to voltage. A material such as silicon, polyimide, or aramid other than the piezoelectric material may be on a surface of the electrode 8 that is not in contact with the vibrating membrane 7, that is, a surface at a smaller z-axis coordinate. This structure is referred to as a bimorph structure. As illustrated in FIG. 7, the electrode 5 may be divided into an electrode 5-1, an electrode 5-2, and an electrode 5-3.

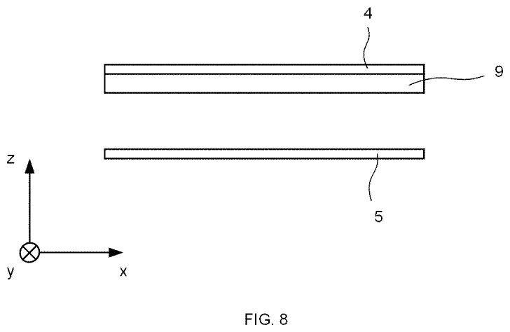

In an example illustrated in FIG. 8, the electrode 4 that corresponds to the first electrode is in contact with a vibrating membrane 9, and the electrode 5 that corresponds to the second electrode is provided at a position away from the vibrating membrane 9 by a predetermined distance. The vibrating membrane 9 corresponds to the vibrating membrane 1 described above and is not composed of a piezoelectric material but is composed of, for example, silicon, polyimide, or aramid. According to this aspect, in the case where a voltage is applied between the electrode 4 and the electrode 5, attraction force (suction force) is exerted between these, and the vibrating membrane 9 vibrates in a y-axis direction in the figure. The thickness of the vibrating membrane 9 is no less than several tens of μm and is, for example, 5 μm. A conductor that has a certain degree of resistivity and that serves as an antistatic layer may be provided on a surface of the vibrating membrane 9 that is not in contact with the electrode 4, that is, a surface in a smaller z-axis coordinate. The purpose of this is to prevent static electricity on the vibrating membrane 9. A gas barrier layer may be provided on a surface of the electrode 4 that is not in contact with the vibrating membrane 9, that is, a surface at a larger z-axis coordinate such that gas does not leak, or the leakage is reduced. The gas is air or an inert gas. The gas barrier layer may be provided between the vibrating membrane 9 and the antistatic layer.

The elements 3 can be configured to enable the resonate frequency of the vibrating membrane 9 to be adjusted by applying a direct bias voltage or to enable strong ultrasound to be emitted with a matching layer added as disclosed in Patent Document 1.

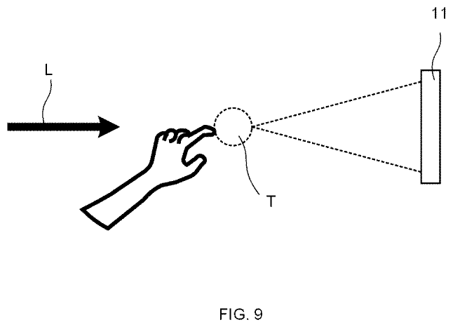

A summary of the ultrasound device will now be described. The ultrasound device is classified into a device that emits the ultrasound and a device that reflects the ultrasound, and these involve phase control under which the phase of the ultrasound is controlled. FIG. 9 illustrates an example in which the ultrasound device that emits the ultrasound is disposed. As illustrated in the figure, an ultrasound device 11 emits the ultrasound such that a person experiences tactile sensation in the case where the person touches a tactile sensation presentation portion T. An arrow L in the figure represents the direction of the line of sight of the person.

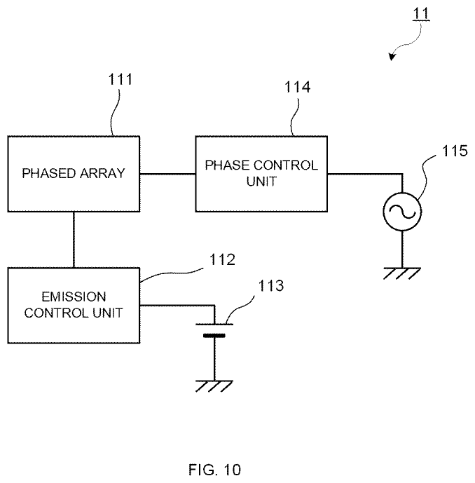

The structure of the ultrasound device 11 will now be described. FIG. 10 illustrates an example of the structure of the ultrasound device 11. As illustrated in the figure, the ultrasound device 11 includes a phased array 111, an emission control unit 112, a direct-current power supply 113, a phase control unit 114, and an alternating-current power supply 115. The phased array 111 includes multiple elements that emit the ultrasound. The emission control unit 112 causes a direct voltage that is applied by the direct-current power supply 113 to be selectively applied to the phased array 111 and consequently controls whether the ultrasound is emitted to the elements that are included in the phased array 111. The phase control unit 114 causes an alternating voltage that is applied by the alternating-current power supply 115 to be applied to the phased array 111 and consequently causes the elements that are included in the phased array 111 to emit the ultrasound at a frequency depending on the frequency of the alternating voltage that is applied by the alternating-current power supply 115. At this time, the phase control unit 114 is capable of selectively inverting the phase of the alternating voltage that is applied to the elements and is capable of causing the elements of the phased array 111 to emit the ultrasound at different phases. The alternating-current power supply 115 may include a first alternating-current power supply and a second alternating-current power supply, and the phase control unit 114 may cause a voltage that is applied by the first alternating-current power supply and a voltage that is applied by the second alternating-current power supply to be selectively applied to the phased array 111. An alternating voltage that is applied by the second alternating-current power supply has a phase into which the phase of an alternating voltage that is applied by the first alternating-current power supply is inverted.

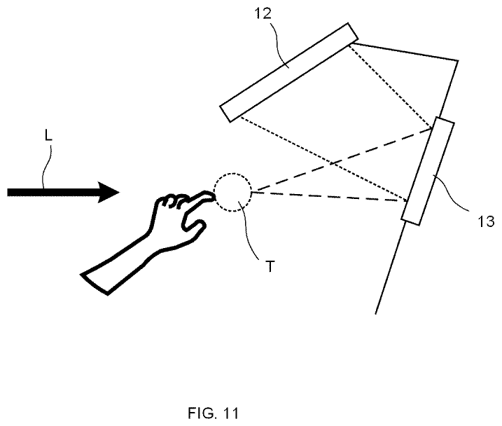

FIG. 11 illustrates an example in which the ultrasound device that reflects ultrasound is disposed. As illustrated in the figure, an ultrasound device 13 reflects the ultrasound that is emitted by an ultrasound device 12. At this time, the ultrasound device 13 reflects the ultrasound such that a person experiences the tactile sensation when the person touches the tactile sensation presentation portion T. An arrow L in the figure represents the direction of the line of sight of the person. For example, the ultrasound device 12 does not need to control the phase of the ultrasound to be emitted provided that the ultrasound at the predetermined frequency is emitted. The ultrasound device 11 may correspond thereto.

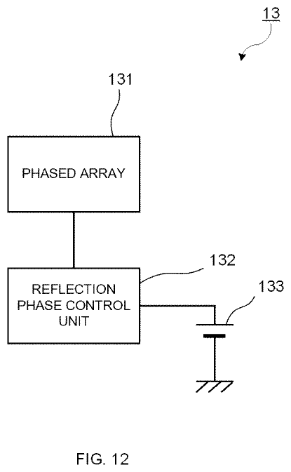

The structure of the ultrasound device 13 will now be described. FIG. 12 illustrates an example of the structure of the ultrasound device 13. As illustrated in the figure, the ultrasound device 13 includes a phased array 131, a reflection phase control unit 132, and a direct-current power supply 133. The phased array 131 includes multiple elements that reflect the ultrasound. The reflection phase control unit 132 causes a direct voltage that is applied by the direct-current power supply 133 to be selectively applied to the phased array 131 and consequently controls whether the ultrasound that is reflected by the elements that are included in the phased array 131 is reflected at the same phase as the incident ultrasound or is reflected at a phase into which the phase of the incident ultrasound is inverted.

### 2. Phased Array

The phased array 111 (131) will now be described.

A phased array corresponds to the phased array 111 or the phased array 131 described above. The phased array 111 (131) includes a vibrating membrane under tension and includes the tension-maintaining means that maintains the tension as described above.

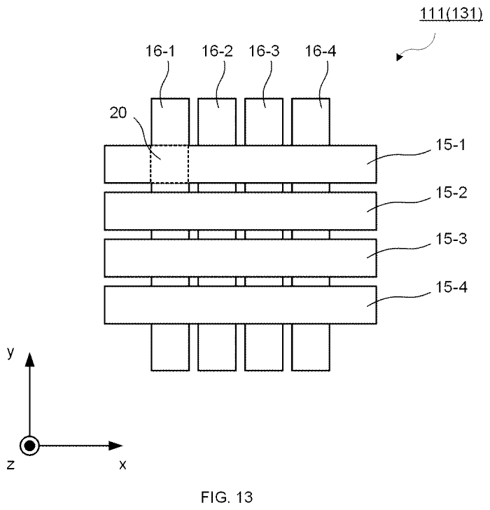

Electrodes that are included in the phased array 111 (131) will now be described. FIG. 13 illustrates an example in which the electrodes are arranged. The phased array 111 (131) includes first electrodes and second electrodes. The first electrodes are conductors that are stacked on a vibrating membrane 150 and are portions of the vibrating membrane 150. The vibrating membrane 150 corresponds to a stack of the electrode 4 and the vibrating membrane 9 that are stacked described above. In the case where the antistatic layer and the gas barrier layer are included, these are included in the vibrating membrane 150. In other words, the first electrodes include the vibrating membrane 150 under tension. The second electrodes are conductors that face the first electrodes.

As illustrated in the figure, the first electrodes include multiple electrodes 15-1, 15-2, 15-3, and 15-4, and the longitudinal directions (the X-axis direction in the figure) of the multiple electrodes are parallel with each other. The second electrodes include multiple electrodes 16-1, 16-2, 16-3, and 16-4, and the longitudinal directions (the Y-axis direction in the figure) of the multiple electrodes are parallel with each other. The longitudinal directions of the first electrodes and the longitudinal directions of the second electrodes intersect with each other. The number of the first electrodes and the number of the second electrodes are not limited to those in the figure and are not necessarily equal to each other. Elements 20 transmit the ultrasound (in the case of the phased array 111) or reflects the ultrasound (in the case of the phased array 131) and are provided at positions at which the first electrodes and the second electrodes intersect with each other. Accordingly, the elements 20 include the first electrodes and the second electrodes. Multiple elements 20 may be disposed at each of the positions at which the first electrodes and the second electrodes intersect with each other.

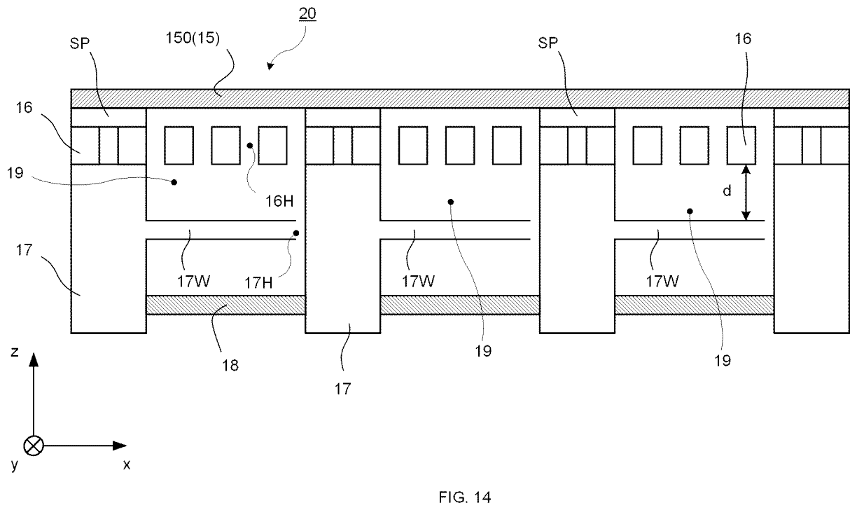

The elements 20 will now be described. FIG. 14 illustrates an example of the structure of each element 20. As illustrated in the figure, the electrodes 15 that correspond to the first electrodes and the electrodes 16 that correspond to the second electrodes face each other.

Each element 20 includes a gas chamber 19 in which gas is enclosed. The gas is air or an inert gas, and an example of the inert gas is sulfur hexafluoride (SF₆) that has high insulating performance. The gas chamber 19 is surrounded by a frame 17, the vibrating membrane 150 (the electrodes 15), and a flexible membrane 18. That is, the vibrating membrane 150 (the electrodes 15) forms a part of a wall portion of the gas chamber 19, and the flexible membrane 18 forms a part of a wall portion of the gas chamber 19. The flexible membrane 18 deforms depending on a difference in atmospheric pressure between locations inside and outside of the gas chamber 19 and reduces the difference in atmospheric pressure. The ultrasound depending on the vibration of the vibrating membrane 150 does not reach because of a wall portion 17W of the frame 17. The wall portion 17W of the frame 17 has a through hole 17H through which the inert gas passes. The gas barrier layer may be provided on a surface of the flexible membrane 18 outside the gas chamber 19, that is, at a smaller z-axis coordinate such that the inert gas does not leak, or the leakage is reduced. The electrodes 16 that correspond to the second electrodes have through holes 16H and are provided in the gas chamber 19. In the gas chamber 19, rigid barriers that prevent the gas from vibrating in the x direction in the figure may be periodically provided.

Distances designated by an arrow d in the figure between surfaces of the electrodes 16 that do not face the electrodes 15 and the wall portion 17W in the gas chamber 19 that faces the vibrating membrane 150 are no less than one eighth of the wavelength when the vibrating membrane 150 (the electrodes 15) resonates and no more than three eighths thereof, and the distances are preferably one fourth of the wavelength. When d=λ/4 is satisfied where A is the wavelength, the acoustic impedance of the vibrating membrane 150 is close to 0 when the vibrating membrane 150 freely vibrates. When d=λ/4+nλ/2 is satisfied instead of d=λ/4, the same effect can be acquired. n is a natural number.

The distances between the vibrating membrane 150 (the electrodes 15) and the electrodes 16 are maintained by spacers SP. The spacers SP are used to ensure a preferred gap length and ensure the gap length in any one of methods described below. The first method is to fix the vibrating membrane 150 and the spacers SP mechanically, and insulating adhesive sheets that have a preferred thickness or adhesive sheets that have conductive front surfaces are used as the spacers SP, and the vibrating membrane 150 and the spacers SP are fixed to each other due to the adhesion thereof. As for the elements 20, a direct voltage and an alternating voltage are applied between the electrodes 15 (the vibrating membrane 150) and the electrodes 16, electrostatic force due to the direct voltage at this time acts on fixed portions between the vibrating membrane 150 and the spacers SP via the adhesive sheets. Consequently, electrostatic fixation is reinforced in addition to mechanical fixation. The fixation due to the electrostatic force may be omitted. In this case, a conductive layered portion of each electrode 16 or the vibrating membrane 150 may be configured as an electret.

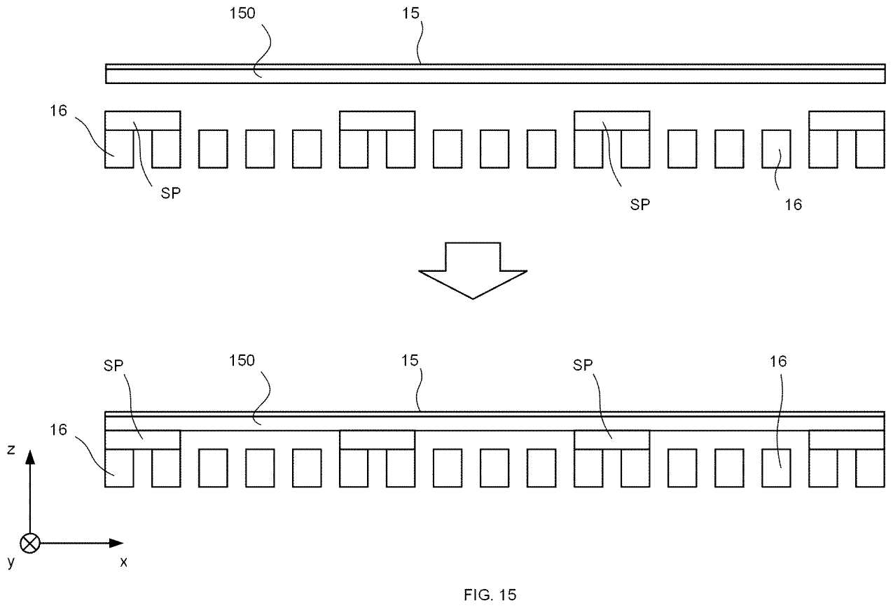

The second method is to fix the vibrating membrane 150 and the spacers SP due to the electrostatic force instead of the mechanical fixation. FIG. 15 is a diagram for describing the method of fixing the spacers SP and the vibrating membrane 150 to each other. As illustrated in the figure, the vibrating membrane 150 and the spacers SP are connected to each other due to the electrostatic force. Specifically, a direct voltage is applied between the electrodes 15 on the vibrating membrane 150 and the spacers SP, and consequently, the electrostatic force is produced between the electrodes 15 and the spacers SP. The direct voltage that is applied at this time differs from a direct voltage for driving the elements 20. Before the direct voltage is applied, the vibrating membrane 150 may be roughly disposed on the spacers SP, that is, the vibrating membrane 150 and the spacers SP may be in contact with each other, or the vibrating membrane 150 may float from the spacers SP. The spacers SP that can be used in the second method are composed of an adhesive sheet that has a conductive front surface, a conductor that has a preferred thickness, or an insulator that has a conductive layer on a front surface. The vibrating membrane 150 and the spacers SP absorb onto each other, and subsequently, this state is maintained due to the electrostatic force. Conductive portions of the spacers SP may be configured as electrets.

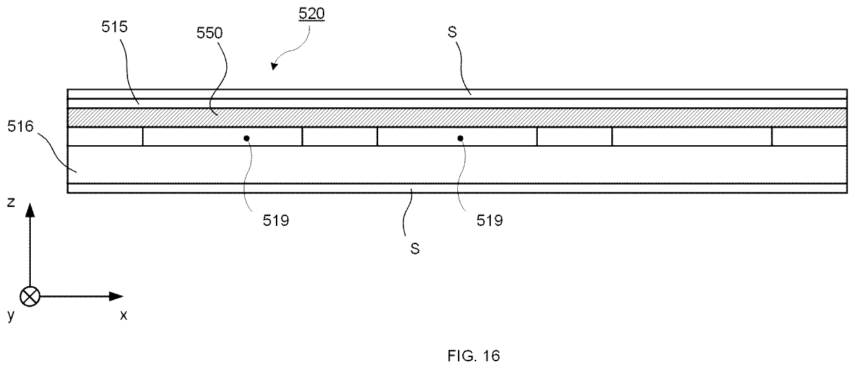

The elements can be configured such that no gas is enclosed between the vibrating membrane and the electrodes. FIG. 16 illustrates an example of the structure of an element 520. The element 520 illustrated in the figure has a space 519 between a vibrating membrane 550 that is in contact with an electrode 515 that corresponds to the first electrode and an electrode 516 that corresponds to the second electrode, and the space 519 is a vacuum space. Sealing materials S are provided on the electrode 515 and the electrode 516. The sealing materials S prevent outside air from entering the space 519. The sealing materials S are not essential.

In the above description, the multiple elements 20 are provided on the vibrating membrane 150, and multiple elements 520 are provided on the vibrating membrane 550, but a single element may be provided on a single vibrating membrane, and multiple elements thus configured may be used.

### 3. Control of Elements

The control of the elements 20 will now be described. The elements 20 are controlled by controlling whether the ultrasound is emitted (in the case of the phased array 111) or by controlling the phase when the ultrasound is reflected (in the case of the phased array 131). In the case where the ultrasound is emitted (in the case of the phased array 111), another control due to an alternating voltage is needed, and this point will be described later.

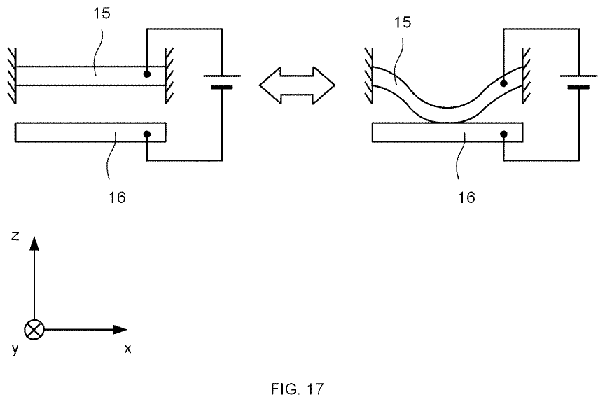

FIG. 17 is a diagram for describing the operation of each element 20. The elements 20 have properties such that the electrodes 15 (the vibrating membrane 150) adsorb onto the electrodes 16 when a direct voltage that has a predetermined value or more is applied between the electrodes 15 (the vibrating membrane 150) and the electrodes 16. Insulators are disposed on lower surfaces of the electrodes 15 (surfaces that face the electrodes 16) although this is omitted in the figure. A state in which the electrodes 15 adsorb onto the electrodes 16 is referred to below as a pull-in state. The predetermined value of the voltage at which the pull-in state occurs is determined by using the spring constant of the vibrating membrane 150 and distances between the electrodes 15 and the electrodes 16. The pull-in state continues while the voltage is applied between the electrodes 15 and the electrodes 16, and the voltage at this time may have a value less than the predetermined value. The pull-in state ends when the value of the voltage that is applied between the electrodes 15 and the electrodes 16 is a prescribed value or less. The prescribed value is a value when the restoring force of a spring of the vibrating membrane 150 is greater than the electrostatic force that acts between the electrodes 15 and the electrodes 16. When the value of the voltage that is applied between the electrodes 15 and the electrodes 16 is 0, the pull-in state ends.

As for the phased array 111, the elements 20 that are in the pull-in state do not emit the ultrasound, and the elements 20 that are not in the pull-in state emit the ultrasound. As for the phased array 131, the elements 20 that are in the pull-in state reflect the incident ultrasound at the same phase as the phase thereof, and the elements 20 that are not in the pull-in state reflect the incident ultrasound at a phase (the phase differs by n) into which the phase thereof is inverted. More precisely, the “reflection at the same phase” means that the sound pressure of the ultrasound is reflected at the same phase, and the “inverted phase” means a state in which the phase of the sound pressure is inverted for the reflection, and ideally, the sound pressure on a reflection surface is zero. In practice, however, the phase of a wave reflected by the reflection surface is not precisely inverted, and the amplitude is slightly reduced for the reflection. Also in this case, a wave front can be controlled. If the phase of the reflected wave is significantly changed in a manner in which two conditions in which the elements 20 are in the pull-in state and in which the elements 20 are not in the pull-in state are switched, the wave front can be controlled.

The ultrasound device 11 illustrated in FIG. 10 includes the direct-current power supply 113 to operate the elements 20 in this manner. The emission control unit 112 causes the direct-current power supply 113 to selectively apply a first voltage and a second voltage between the electrodes 15 that correspond to the first electrodes and the electrodes 16 that correspond to the second electrodes. The first voltage is equal to or more than a voltage value at which the vibrating membrane 150 adsorbs onto the electrodes 16. The second voltage is less than the voltage value at which the vibrating membrane 150 adsorbs onto the electrodes 16. For example, the direct-current power supply 113 selectively applies a first potential and a second potential to either the electrodes 15 or the electrodes 16 and selectively applies the first potential and a third potential to the other of the electrodes 15 and the electrodes 16. A difference between the first potential and the second potential is equal to the second voltage, a difference between the second potential and the third potential is equal to the second voltage, and a difference between the first potential and the third potential is equal to the first voltage. Similarly, the ultrasound device 13 includes the direct-current power supply 133. The reflection phase control unit 132 causes the direct-current power supply 133 to selectively apply the first voltage and the second voltage between the electrodes 15 that correspond to the first electrodes and the electrodes 16 that correspond to the second electrodes. The first voltage is equal to or more than the voltage value at which the vibrating membrane 150 adsorbs onto the electrodes 16. The second voltage is less than the voltage value at which the vibrating membrane 150 adsorbs onto the electrodes 16. For example, the direct-current power supply 113 selectively applies the first potential and the second potential to either the electrodes 15 or the electrodes 16 and selectively applies the first potential and the third potential to the other of the electrodes 15 and the electrodes 16. The difference between the first potential and the second potential is equal to the second voltage, the difference between the second potential and the third potential is equal to the second voltage, and the difference between the first potential and the third potential is equal to the first voltage.

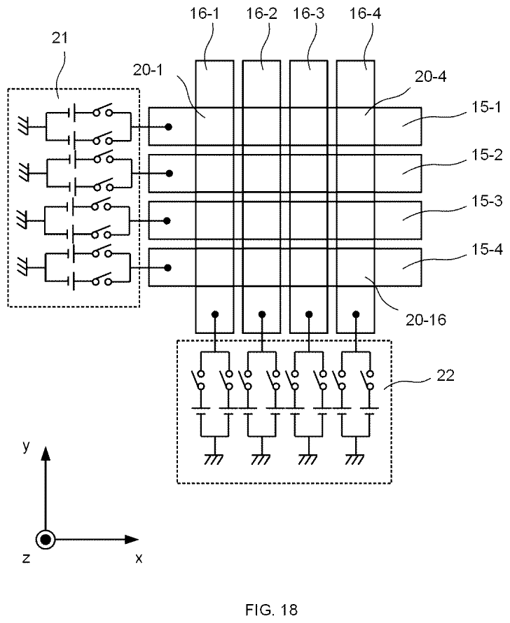

A specific example of the control of the elements 20 will now be described. FIG. 18 is a diagram for describing the control of each element 20. As illustrated in the figure, as for the elements 20, a row control unit 21 applies a direct voltage that has a voltage value of VH or VL to the electrodes 15-1, 15-2, 15-3, and 15-4, and a column control unit 22 applies a direct voltage that has a voltage value of VH or VM to the electrodes 16-1, 16-2, 16-3, and 16-4. The row control unit 21 and the column control unit 22 are respectively included in the emission control unit 112 and the reflection phase control unit 132. The voltage VH, the voltage VM, and the voltage VL can be combined into various combinations such as a combination of 300 V, 150 V, and 0 V, a combination of 310 V, 160 V, and 10 V, and a combination of 150 V, 0 V, and −150 V.

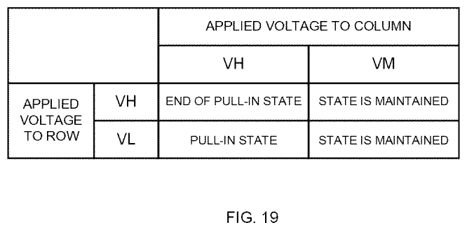

FIG. 19 illustrates a combination of a voltage that is applied to each element 20 and the state of the element at this time. The voltage VH, the voltage VM, and the voltage VL described herein are 300 V, 150 V, and 0 V. For example, in FIG. 18, when the row control unit 21 applies the voltage VH to the electrode 15-1, the column control unit 22 applies the voltage VH to the electrode 16-1, the difference in potential between the electrode 15-1 and the electrode 16-1 is 0, that is, no voltage is applied to these, and an element 20-1 exits the pull-in state. When the row control unit 21 applies the voltage VL to the electrode 15-1, and the column control unit 22 applies the voltage VH to the electrode 16-1, the difference in potential between the electrode 15-1 and the electrode 16-1 is 300 V, and the element 20-1 is in the pull-in state. In the case where the row control unit 21 applies the voltage VH to the electrode 15-1, and the column control unit 22 applies the voltage VM to the electrode 16-1, and in the case where the row control unit 21 applies the voltage VL to the electrode 15-1, and the column control unit 22 applies the voltage VM to the electrode 16-1, the difference in potential between the electrode 15-1 and the electrode 16-1 is 150 V, the element 20-1 continues to be in the pull-in state if being in the pull-in state right before, and the element 20-1 continues not to be in the pull-in state if being not in the pull-in state right before.

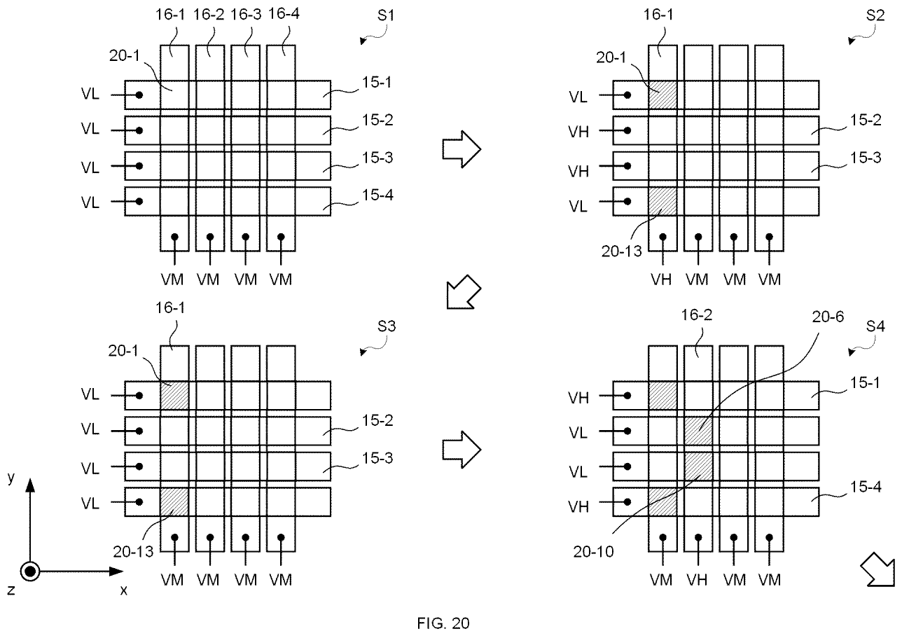

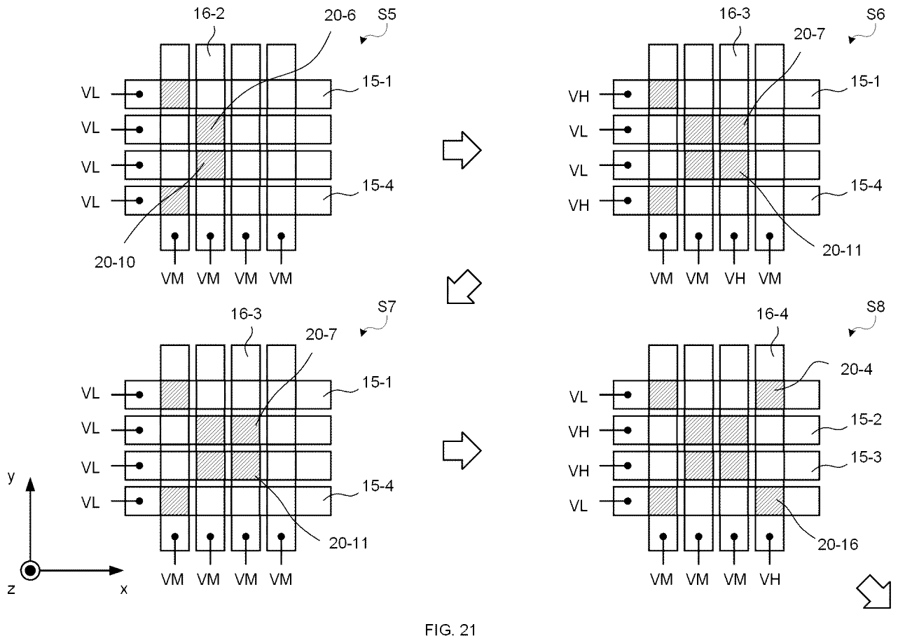

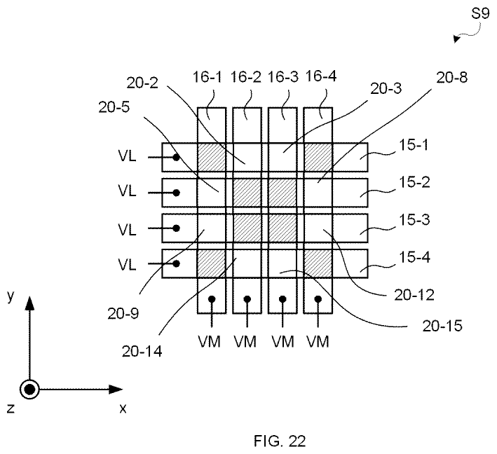

The flow of pattern generation when the ultrasound is emitted or reflected by controlling the elements 20 will now be described. FIG. 20 to FIG. 22 illustrate the flow of pattern generation. As illustrated by using S1, the row control unit 21 changes the potential of the electrodes 15-1, 15-2, 15-3, and 15-4 into VL, and the column control unit 22 changes the potential of the electrodes 16-1, 16-2, 16-3, and 16-4 into VM. Subsequently, as illustrated by using S2, when the row control unit 21 changes the potential of 15-2 and 15-3 into VH, and the column control unit 22 changes the potential of the electrode 16-1 into VH, the element 20-1 and an element 20-13 are brought into the pull-in state.

Subsequently, as illustrated by using S3, when the row control unit 21 changes the potential of the electrodes 15-1, 15-2, 15-3, and 15-4 into VL, and the column control unit 22 changes the potential of the electrodes 16-1, 16-2, 16-3, and 16-4 into VM, the pull-in state of the element 20-1 and the element 20-13 is maintained. As illustrated by using S4, when the row control unit 21 changes the potential of 15-1 and 15-4 into VH, and the column control unit 22 changes the potential of the electrode 16-2 into VH, an element 20-6 and an element 20-10 are brought into the pull-in state. At this time, the pull-in state of the element 20-1 and the element 20-13 is maintained.

Subsequently, as illustrated by using S5, when the row control unit 21 changes the potential of the electrodes 15-1, 15-2, 15-3, and 15-4 into VL, and the column control unit 22 changes the potential of the electrodes 16-1, 16-2, 16-3, and 16-4 into VM, the pull-in state of the element 20-1, the element 20-6, the element 20-10, and the element 20-13 is maintained. As illustrated by using S6, when the row control unit 21 changes the potential of 15-1 and 15-4 into VH, and the column control unit 22 changes the potential of the electrode 16-3 into VH, an element 20-7 and an element 20-11 are brought into the pull-in state. At this time, the pull-in state of the element 20-1, the element 20-6, the element 20-10, and the element 20-13 is maintained.

Subsequently, as illustrated by using S7, when the row control unit 21 changes the potential of the electrodes 15-1, 15-2, 15-3, and 15-4 into VL, and the column control unit 22 changes the potential of the electrodes 16-1, 16-2, 16-3, and 16-4 into VM, the pull-in state of the element 20-1, the element 20-6, the element 20-7, the element 20-10, the element 20-11, and the element 20-13 is maintained. As illustrated by using S8, when the row control unit 21 changes the potential of 15-2 and 15-3 into VH, and the column control unit 22 changes the potential of the electrode 16-4 into VH, an element 20-4 and an element 20-16 are brought into the pull-in state. At this time, the pull-in state of the element 20-1, the element 20-6, the element 20-7, the element 20-10, the element 20-11, and the element 20-13 is maintained.

As illustrated by using S7, when the row control unit 21 changes the potential of the electrodes 15-1, 15-2, 15-3, and 15-4 into VL, and the column control unit 22 changes the potential of the electrodes 16-1, 16-2, 16-3, and 16-4 into VM, an element 20-2, an element 20-3, an element 20-5, an element 20-8, an element 20-9, an element 20-12, an element 20-14, and an element 20-15 are not brought into the pull-in state, but the pull-in state of the other elements is maintained, and the pattern is generated.

As for the control of the elements 20, the order from S1 to S7, that is, the order in which the potential is changed into VH may not be the order of the electrodes 16-1, 16-2, 16-3, and 16-4 but may be reversed or may be freely determined. The control may be implemented such that only the state of the elements 20 that are needed may be changed. In order to change the potential from VL into VH or from VH into VL with the pull-in state maintained, the voltage is changed in a sufficiently short time such that accumulated charge to the elements 20 is not discharged.

### 4. Emission Control

The ultrasound device 11 will now be described.

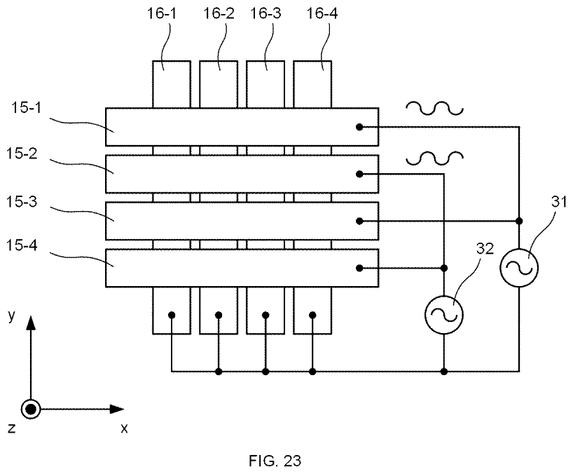

As illustrated in FIG. 10, the ultrasound device 11 includes the alternating-current power supply 115. The alternating-current power supply 115 applies the voltage at the predetermined frequency between the electrodes 15 and the electrodes 16. At this time, the elements 20 emit the ultrasound depending on the predetermined frequency. Regardless of whether the elements 20 that are in the pull-in state do not emit the ultrasound or emit the ultrasound, the intensity thereof is sufficiently low and can be ignored unlike an element that is not in the pull-in state. The alternating-current power supply 115 may include the first alternating-current power supply and the second alternating-current power supply. In this case, the second alternating-current power supply outputs a voltage that has a phase into which the phase of a voltage that is outputted by the first alternating-current power supply is inverted. The alternating-current power supply 115 may not include the second alternating-current power supply, and the phase control unit 114 may invert the phase of the alternating-current power supply 115. The first alternating-current power supply and the second alternating-current power supply apply the voltage at the predetermined frequency between the electrodes 15 and the electrodes 16 of respective different elements 20. An example in which an alternating voltage is applied will now be described. FIG. 23 illustrates the example in which the alternating voltage is applied. As illustrated in the figure, a first alternating-current power supply 31 applies the alternating voltage to the electrode 15-1 and the electrode 15-3, and a second alternating-current power supply 32 applies the alternating voltage to the electrode 15-2 and the electrode 15-4.

As illustrated in FIG. 10, the ultrasound device 11 includes the emission control unit 112. The emission control unit 112 controls the direct voltage that is applied between the electrodes 15 and the electrodes 16 such that the vibrating membrane 150 at the element 20 that emits the ultrasound among the elements 20 does not adsorb onto the electrode 16 and controls the direct voltage that is applied between the electrodes 15 and the electrodes 16 such that the vibrating membrane 150 at the element that does not emit the ultrasound among the elements 20 adsorbs onto the electrode 16. Emission points of the ultrasound that has a phase and emission points of the ultrasound that has the inverted phase are thus located at intersection points of the electrodes 15 and the electrodes 16, and consequently, 1-bit phase control type of an ultrasound phased array is provided.

### 5. Reflection Phase Control

The ultrasound device 13 will now be described.

As illustrated in FIG. 12, the ultrasound device 13 includes the reflection phase control unit 132. The reflection phase control unit 132 controls the voltage that is applied between the electrodes 15 and the electrodes 16 such that the vibrating membrane 150 at the element that reflects the emitted ultrasound at the first phase among the elements 20 adsorbs onto the electrode 16 and controls the voltage that is applied between the electrodes 15 and the electrodes 16 such that the vibrating membrane 150 at the element that reflects the emitted ultrasound at the second phase among the elements 20 does not adsorb onto the electrode 16. For example, the first phase is equal to the phase of the ultrasound that is emitted to the element 20, which more precisely means that the sound pressure of the ultrasound is reflected at the same phase. However, it is not necessary to be precisely equal to the phase. For example, the second phase is the phase into which the phase of the ultrasound that is emitted to the elements 20 is inverted, which more precisely means that the phase of the sound pressure is inverted for reflection, and the sound pressure on the reflection surface is ideally zero. However, it is not necessary to be precisely the inverted phase.

### 6. 1 Bit Phase Control

The ultrasound device 11 and the ultrasound device 13 control the ultrasound that has a phase and the ultrasound that has the inverted phase, which is 1-bit phase control.

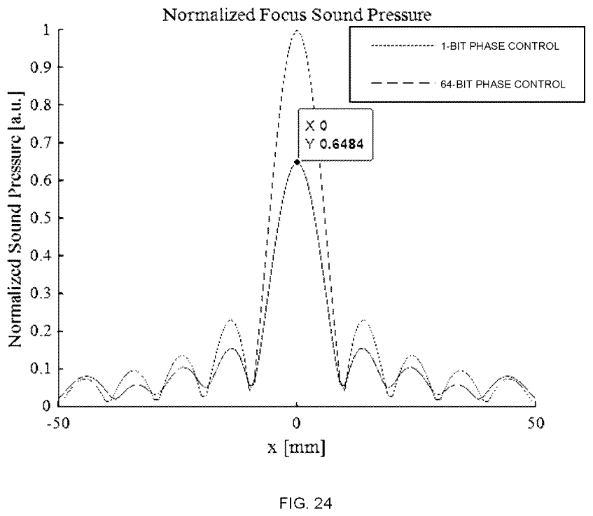

Some of the results of simulations for comparison between the 1-bit phase control and 64-bit phase control will now be described. FIG. 24 to FIG. 30 illustrate sound pressure distribution in the results of the simulations.

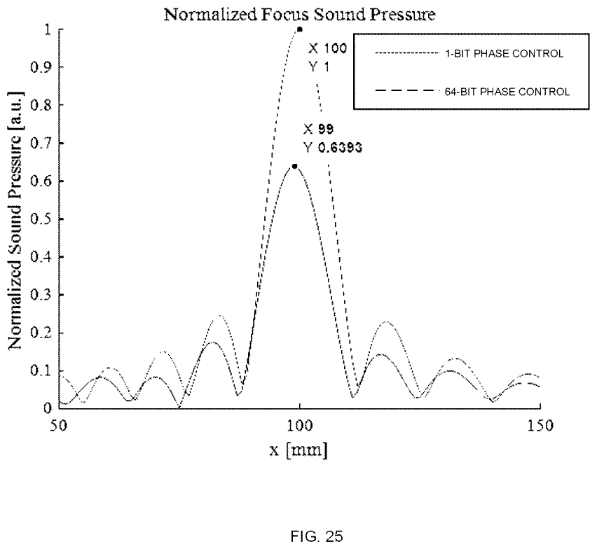

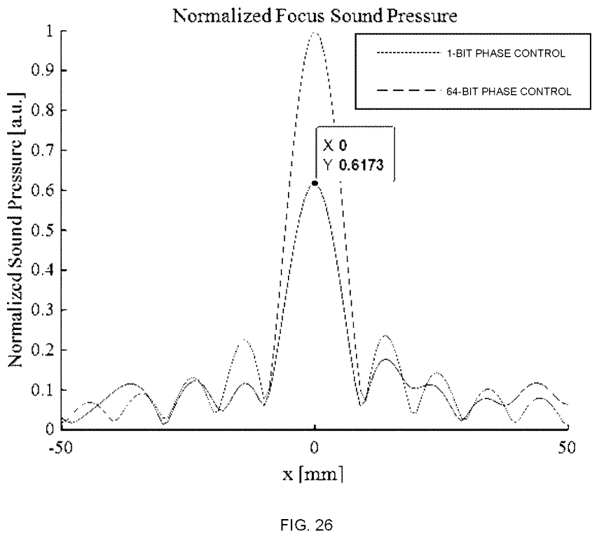

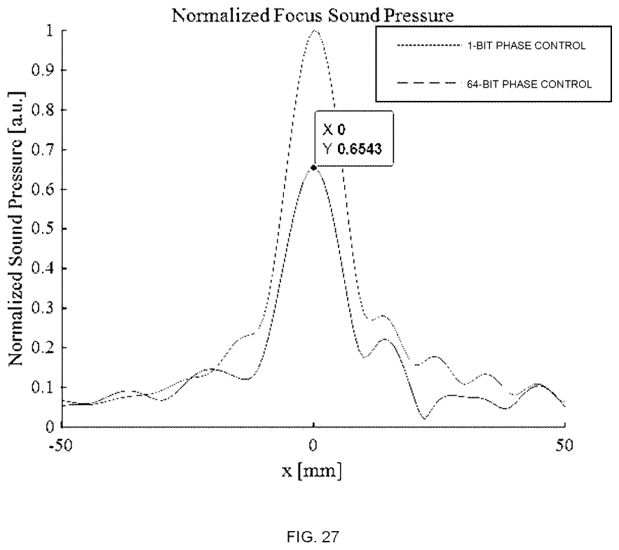

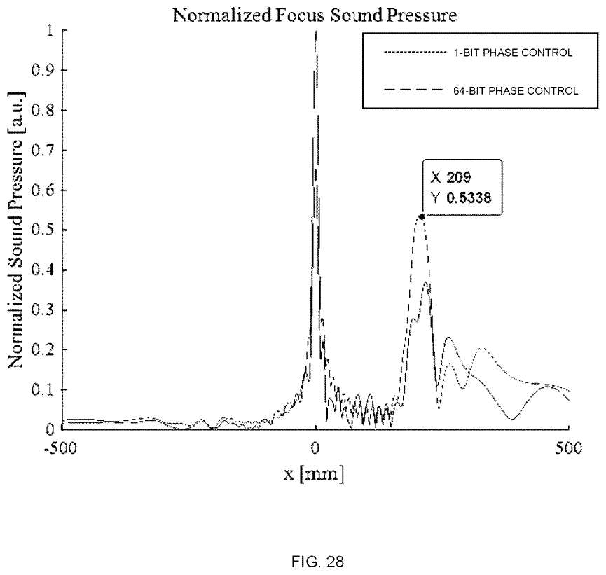

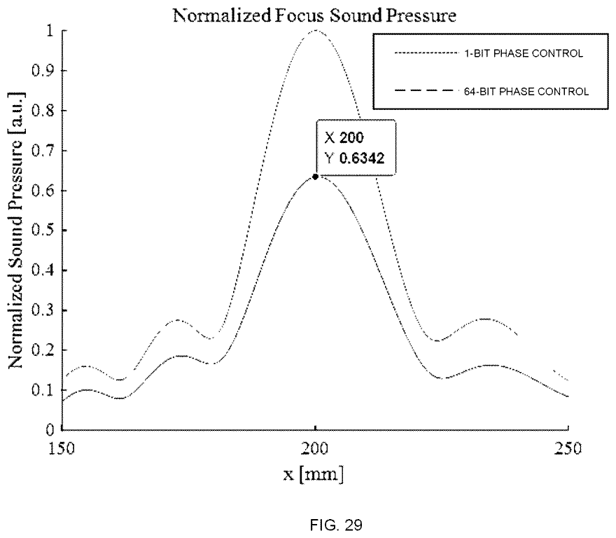

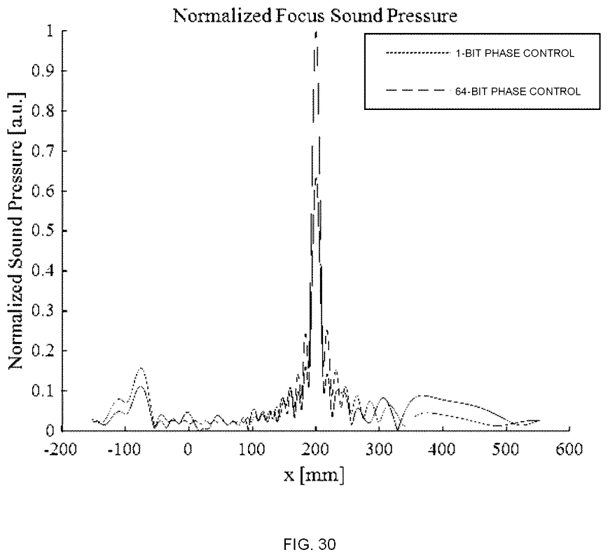

The result of the simulation illustrated in FIG. 24 is acquired in the case of vertical incidence with a focus being on a central axis. The result of the simulation illustrated in FIG. 25 is acquired in the case of the vertical incidence with the focus being on an axis separated from the central axis. The result of the simulation illustrated in FIG. 26 is acquired in the case of oblique incidence with the focus being on the central axis. The result of the simulation illustrated in FIG. 27 is acquired in the case of the oblique incidence at an incident angle that differs from that in FIG. 26 with the focus being on the central axis. FIG. 28 illustrates the result illustrated in FIG. 27 in a different display range. The result of the simulation illustrated in FIG. 29 is acquired in the case of the oblique incidence with the focus being in a reflection direction. FIG. 30 illustrates the result illustrated in FIG. 29 in a different display range.

In the case of the 1-bit phase control and in the case of the 64-bit phase control, the results differ from each other, but the same tendency is displayed as described above, and it is confirmed that there is no problem in practice.

### 7. Usage Aspect of Ultrasound Device

An example of the usage aspect of the ultrasound device will now be described.

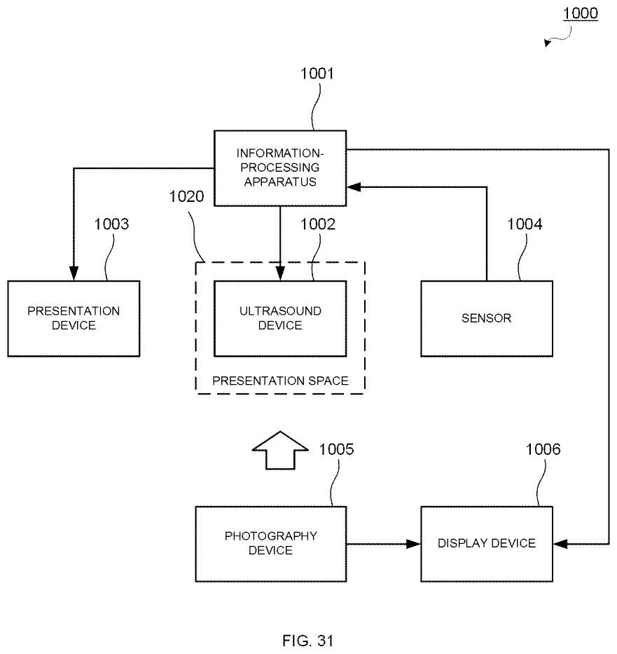

FIG. 31 illustrates an example of the structure of a system that includes an ultrasound device.

A system 1000 illustrated in the figure presents texture together with, for example, an image to a user.

As illustrated in the figure, the system 1000 includes an information-processing apparatus 1001, an ultrasound device 1002, a presentation device 1003, a sensor 1004, a photography device 1005, and a display device 1006. Some or all of the information-processing apparatus 1001, the ultrasound device 1002, the presentation device 1003, and the sensor 1004 may be integrated. Multiple ultrasound devices 1002, multiple presentation devices 1003, multiple sensors 1004, multiple photography devices 1005, and multiple display devices 1006 may be used. At this time, multiple sets of a combination of the ultrasound device 1002, the presentation device 1003, the sensor 1004, the photography device 1005, and the display device 1006 may be provided for the single information-processing apparatus 1001.

The system 1000 may use multiple similar systems in the same space, or multiple systems 1000 may be used in multiple different spaces. In the case where the multiple systems 1000 are used, the systems 1000 may be connected to a network, may be connected to each other, or may be connected with the information-processing apparatus 1001 of any one of these operating as a master.

The information-processing apparatus 1001 operates as a control device that controls the ultrasound device 1002. The ultrasound device 1002 presents texture due to the ultrasound. The ultrasound device 11 or the ultrasound device 13 described above may be used as the ultrasound device 1002. The ultrasound device 1002 is provided in a presentation space 1020. The presentation space 1020 is a space in which ultrasound energy that is produced by the ultrasound device 1002 is confined, and a sound-absorbing material, for example, is used. It is not necessary for the ultrasound energy to be completely confined, for example, provided that the ultrasound energy is reduced to a such an extent that an audible noise does not reach the user near the presentation space. In the case where the user and a peripheral device are critically affected, the presentation space 1020 may be omitted. The ultrasound device 1002 is preferably provided above the line of sight of a person to whom the texture is presented. For example, the presentation device 1003 presents a three-dimensional image to the person, and includes a display. The presentation device 1003 may include a voice-presenting device that presents a voice to the person. An example of the voice-presenting device is an electronic device that includes an analog filter that shields the ultrasound that is produced by the ultrasound device 1002. For example, the sensor 1004 detects the position or movement, the age, the gender, the hand movement, the line of sight, the fingerprint, the voice, the facial expression of the person and an environmental sound, and examples thereof include an optical sensor and a microphone. The photography device 1005 photographs the situation of the person (including the voice). The display device 1006 displays the result of photography performed by the photography device 1005 or the result of sensing the user in the information-processing apparatus 1001, the image to be presented, and the voice. The use of these enables the situation of the person who experiences the system 1000 to be checked by many people. The photography device 1005 and the display device 1006 are not essential components. The information-processing apparatus 1001 and the display device 1006 may not be disposed near a presentation location (for example, a neighbor) such as the presentation space 1020 but may be disposed at different positions.

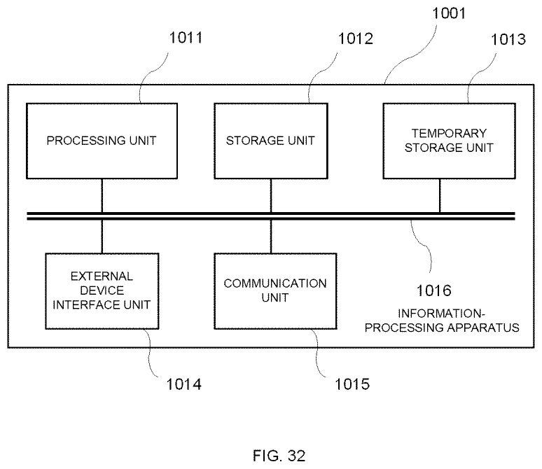

An example of the structure of the information-processing apparatus 1001 will now be described. FIG. 32 illustrates an example of the structure of the information-processing apparatus 1001. As illustrated in the figure, the information-processing apparatus 1001 includes a processing unit 1011, a storage unit 1012, a temporary storage unit 1013, an external device interface unit 1014, and a communication unit 1015, and these components are connected in the information-processing apparatus 1001 so as to be capable of transmitting and receiving a signal via a communication bus 1016. The information-processing apparatus 1001 is a computer and operates in accordance with a program. When the information-processing apparatus 1001 operates, one or more computers suffice, and multiple computers may be used. The program causes at least one computer to operate as the information-processing apparatus 1001.

The processing unit 1011 operates by using, for example, a central processing unit (CPU) in accordance with a predetermined program that is stored in the storage unit 1012 and fulfills various functions.

The storage unit 1012 is a non-volatile storage medium that stores various kinds of information. Examples of this include storage devices such as a hard disk drive (HDD) and a solid state drive (SSD). The storage unit 1012 can be disposed in another device that is communicable.

The temporary storage unit 1013 is a volatile storage medium. Examples of this include memories such as a random access memory (RAM) and store information (such as a parameter and an array) that is temporarily needed when the processing unit 1011 operates.

The external device interface unit 1014 conforms to a standard such as the universal serial bus (USB) or high-definition multimedia interface (HDMI (register trademark)), and an input device such as a keyboard or a display device such as a monitor can be connected thereto.

The communication unit 1015 is a communication means that conforms to a standard for, for example, a local area network (LAN) and enables communication between the information-processing apparatus 1001 and the local area network or a network such as the internet via this.

A computer or a personal computer suitable for a general-purpose server can be used for the information-processing apparatus 1001, and the information-processing apparatus 1001 may include multiple computers.

A functional structure of the information-processing apparatus 1001 will now be described.

The information-processing apparatus 1001 operates as the control device, controls the ultrasound device 1002, and serves as functional units described later by operating in accordance with the program. The program causes at least one computer to operate as a control device 1100.

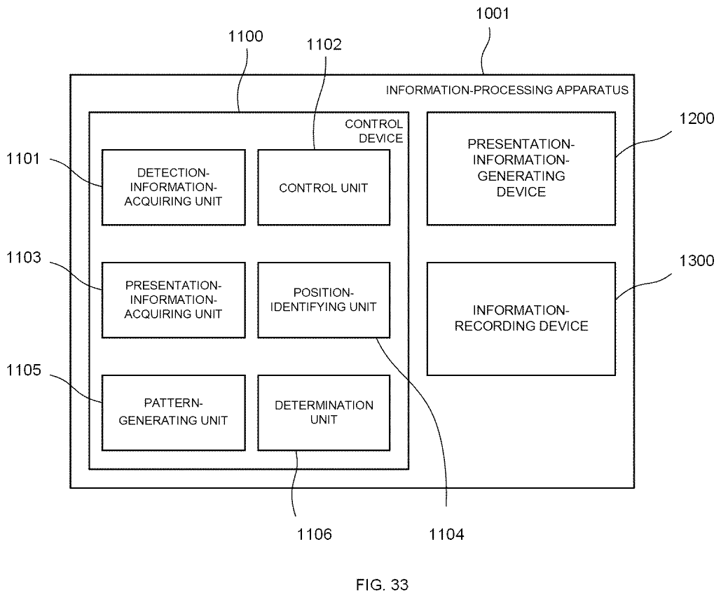

FIG. 33 is a block diagram illustrating the functional structure of the information-processing apparatus 1001. As illustrated in the figure, the information-processing apparatus 1001 includes the functional units such as the control device 1100, a presentation-information-generating device 1200, and an information-recording device 1300. Another information-processing apparatus that differs from the information-processing apparatus 1001 may serve as the presentation-information-generating device 1200 and the information-recording device 1300.

The control device 1100 includes a detection-information-acquiring unit 1101, a control unit 1102, a presentation-information-acquiring unit 1103, a position-identifying unit 1104, a pattern-generating unit 1105, and a determination unit 1106.

The detection-information-acquiring unit 1101 acquires, as detection information, the output of the sensor 1004 that detects the presence of an object at a predetermined position. An example of the object is a person who uses the system 1000. The person may mean a single person or multiple people. An example of the predetermined position is a position of a space that is visually recognized by the person as a space in which the image that is presented by the presentation device 1003 is present. The predetermined position may be a position that is identified by the position-identifying unit 1104. The predetermined position may include multiple positions.

The control unit 1102 transmits, to the ultrasound device 1002, a control signal for emitting the ultrasound to the predetermined position depending on the detection information that is acquired by the detection-information-acquiring unit 1101 and controls the ultrasound device 1002. At this time, the control unit 1102 transmits, to the ultrasound device 1002, the control signal depending on a tactile sensation pattern that is generated by the pattern-generating unit 1105. In the case where the predetermined position includes the multiple positions, the control unit 1102 causes the ultrasound device 1002 to emit the ultrasound to the multiple positions. The control unit 1102 may transmit, to multiple ultrasound devices 1002, the control signal for emitting the ultrasound.

The presentation-information-acquiring unit 1103 acquires presentation information including an image. The presentation information is generated by the presentation-information-generating device 1200 and is provided to the presentation device 1003, and the presentation-information-acquiring unit 1103 acquires the presentation information that is generated by the presentation-information-generating device 1200.

The position-identifying unit 1104 identifies the predetermined position described above, based on the presentation information. An example of the predetermined position is a position of a space that is visually recognized by the person as a space in which a presented object, for example, is present.

The pattern-generating unit 1105 generates the tactile sensation pattern, based on the presentation information. The tactile sensation pattern is sensed by, for example, the user. For example, in the case where the presentation information represents an image of a character doll, the tactile sensation pattern differs depending on the position of a portion of the doll, and something that the person feels such as “jelly-like”, “slimy”, or “fluffy” is generated depending on the predetermined position.

The determination unit 1106 determines at least the age, the gender, the hand movement, or the line of sight of the person, based on the output of the sensor and records the result of determination in the information-recording device 1300. In the case where another information-processing apparatus that differs from the information-processing apparatus 1001 serves as the information-recording device 1300, the control device 1100 and the information-recording device 1300 are connected by using a network regardless of wired or wireless connection. The determination unit 1106 determines whether the object is a hand of the person and determines movement of the hand in the case where the object is the hand. Examples of the movement of the hand that is determined by the determination unit 1106 include movement for pressing a finger against an object on the image, movement for grabbing the object on the image, movement for lifting the object on the image, and movement for moving or rotating the object on the image. After the determination unit 1106 makes the determination, the pattern-generating unit 1105 generates the tactile sensation pattern depending on the result of determination of the determination unit 1106. For example, the tactile sensation pattern is something that the person feels such as “jelly-like”, “slimy”, or “fluffy”. The determination unit 1106 may determine whether the object is another portion such as the face or the forearm in addition to whether the object is the hand of the person. For example, in the case where the system 1000 is used for a situation voice or a massage, the tactile sensation is presented to the face. In this case, a voice is used as the presentation information instead of the image, and the voice and the tactile sensation are presented. In the case where the massage is given, the voice is unnecessary, and only the tactile sensation may be presented.

The system 1000 can be used for the following purpose. For example, in the case of a use for a touchable advertisement, a touch enables an interest in, for example, a product to be attracted. For use in the advertisement, it is particularly thought that information that is recorded in the information-recording device 1300 is used, and for example, it is thought that an advertisement content is changed depending on the attributes of the person. It is also possible to record which types of people are interested in which types of content in consideration of privacy and to analyze this afterward. In addition, the use in, for example, a theme park, a museum, an aquarium, or a zoo enables a simulated touch on characters, art crafts, or animals. In addition, a touch on a creature that is imaginarily displayed as a virtual pet enables healing to be provided. In addition, remote communication with mutual touches can be established, and the use in an EC site, for example, enables the texture, size, and so on of a product to be checked during online shopping. In addition, the use can be made also for designing, a design tool, addition of the texture into the situation voice, and the massage.

Examples of a conceivable location at which the system 1000 is installed include a toilet, an elevator, a restaurant, a storefront, a location inside a station, a location inside a vehicle, and a cabin, public spaces such as an enclosed work space, and personal spaces such as a house and a car. When the system 1000 is installed, a system that prevents the user from perceiving the ultrasound that propagates in a space may be provided. For example, the use of a sound-absorbing material when the ultrasound device is disposed causes the ultrasound energy to be confined in the space of the system. Realistic feeling can be improved in a manner in which an analog filter is added into an electronic device that is exposed to the ultrasound such as a noise-canceling earphone, a smartphone, or a PC, or the system is disposed on the line of sight of the user.

### 8. Others

The present invention can be provided in aspects described below.

(1) An ultrasound device comprising: a vibrating membrane; a tension-maintaining means; and multiple elements, wherein the vibrating membrane is provided under tension, wherein the tension-maintaining means supports the vibrating membrane and does not deform due to restoring force of the vibrating membrane, and wherein the elements are periodically provided on the vibrating membrane, and each of the elements includes a first electrode and a second electrode, wherein the first electrode is in contact with the vibrating membrane, and wherein the second electrode faces the first electrode.

(2) The ultrasound device according to (1), wherein the elements are provided on a substrate, wherein the substrate is periodically fixed to the vibrating membrane, and wherein the vibrating membrane has a region that is surrounded by a fixed portion of the substrate and that resonates at a predetermined frequency.

(3) The ultrasound device according to (1) or (2), wherein the tension-maintaining means includes an elastic body and maintains the tension that is applied to the vibrating membrane by using the elastic body.

(4) The ultrasound device according to any one of (1) to (3), wherein the second electrode is in contact with the vibrating membrane, wherein the second electrode is provided on a back surface of the vibrating membrane in a case where the first electrode is provided on a front surface of the vibrating membrane, and wherein the first electrode is provided on the back surface of the vibrating membrane in a case where the second electrode is provided on the front surface of the vibrating membrane.

(5) The ultrasound device according to any one of (1) to (3), wherein the elements include a gas chamber in which gas is enclosed, wherein the vibrating membrane forms a part of a wall portion of the gas chamber, and wherein the second electrode has a through hole and is provided in the gas chamber.

(6) The ultrasound device according to (5), wherein a distance between a surface of the second electrode that does not face the first electrode and the wall portion of the gas chamber that faces the vibrating membrane is no less than one eighth and no more than three eighths of a wavelength at which the vibrating membrane resonates.

(7) The ultrasound device according to (6), wherein the distance is one fourth of the wavelength.

(8) The ultrasound device according to any one of (5) to (7), wherein the gas chamber includes a flexible membrane, and wherein the flexible membrane forms the part of the wall portion of the gas chamber, deforms depending on a difference in atmospheric pressure between locations inside and outside of the gas chamber, and reduces the difference in atmospheric pressure.

(9) The ultrasound device according to (5) or (8), wherein the gas is an inert gas.

(10) The ultrasound device according to (9), wherein the inert gas is sulfur hexafluoride.

(11) The ultrasound device according to any one of (1) to (3), wherein the elements have a vacuum space between the vibrating membrane and the second electrode.

(12) The ultrasound device according to any one of (1) to (11), further comprising: a direct-current power supply, wherein the direct-current power supply selectively applies a first voltage and a second voltage between the first electrode and the second electrode, wherein the first voltage is a voltage equal to or more than a voltage at which the vibrating membrane adsorbs onto the second electrode, and wherein the second voltage is a voltage less than the voltage at which the vibrating membrane adsorbs onto the second electrode.

(13) The ultrasound device according to (12), wherein the direct-current power supply selectively applies first potential and second potential to either the first electrode or the second electrode and selectively applies the first potential and third potential to the other of the first electrode and the second electrode, wherein a difference between the first potential and the second potential is equal to the second voltage, wherein a difference between the second potential and the third potential is equal to the second voltage, and wherein a difference between the first potential and the third potential is equal to the first voltage.

(14) The ultrasound device according to (12) or (13), wherein the first electrode includes multiple electrodes, and longitudinal directions of the multiple electrodes are parallel with each other, wherein the second electrode includes multiple electrodes, and longitudinal directions of the multiple electrodes are parallel with each other, wherein a longitudinal direction of the first electrode and a longitudinal direction of the second electrode intersect with each other, and wherein the elements are provided at a position at which the first electrode and the second electrode intersect with each other.

(15) The ultrasound device according to any one of (1) to (14), further comprising: a reflection phase control unit, wherein the reflection phase control unit controls a voltage that is applied between the first electrode and the second electrode such that the vibrating membrane at an element that reflects ultrasound emitted to the element at a first phase among the elements adsorbs onto the second electrode and controls the voltage that is applied between the first electrode and the second electrode such that the vibrating membrane at an element that reflects ultrasound emitted to the element at a second phase among the elements does not adsorb onto the second electrode.

(16) The ultrasound device according to (15), wherein the first phase is equal to a phase of the ultrasound emitted to the element, and wherein the second phase is a phase into which the phase of the ultrasound emitted to the element is inverted.

(17) The ultrasound device according to any one of (1) to (14), further comprising: an alternating-current power supply, wherein the alternating-current power supply applies a voltage at a predetermined frequency between the first electrode and the second electrode, and wherein the elements emit ultrasound depending on the predetermined frequency.

(18) The ultrasound device according to (17), wherein the alternating-current power supply includes a first alternating-current power supply and a second alternating-current power supply, wherein the second alternating-current power supply outputs a voltage that has a phase into which a phase of a voltage that is outputted by the first alternating-current power supply is inverted, and wherein the first alternating-current power supply and the second alternating-current power supply apply the voltage at the predetermined frequency between the first electrodes and the second electrodes of the respective different elements.

(19) The ultrasound device according to (17) or (18), further comprising: an emission control unit, wherein the emission control unit controls a direct voltage that is applied between the first electrode and the second electrode such that the vibrating membrane at an element that emits the ultrasound among the elements does not adsorb onto the second electrode and controls the direct voltage that is applied between the first electrode and the second electrode such that the vibrating membrane at an element that does not emit the ultrasound among the elements adsorbs onto the second electrode.

(20) An ultrasound device comprising: an element; and a reflection phase control unit, wherein the element includes a vibrating membrane, a first electrode, and a second electrode, wherein the vibrating membrane is under tension, wherein the first electrode is in contact with the vibrating membrane, wherein the second electrode faces the first electrode, and wherein the reflection phase control unit controls a voltage that is applied between the first electrode and the second electrode such that the vibrating membrane adsorbs onto the second electrode in a case where ultrasound emitted to the element is reflected at a first phase and controls the voltage that is applied between the first electrode and the second electrode such that the vibrating membrane does not adsorb onto the second electrode in a case where the ultrasound emitted to the element is reflected at a second phase.

(21) The ultrasound device according to (20), wherein the first phase is equal to a phase of the ultrasound emitted to the element, and wherein the second phase is a phase into which the phase of the ultrasound emitted to the element is inverted.

(22) A control device that controls an ultrasound device, the control device comprising: a detection-information-acquiring unit and a control unit, wherein the detection-information-acquiring unit acquires, as detection information, an output of a sensor that detects presence of an object at a predetermined position, and wherein the control unit transmits, to the ultrasound device, a control signal for emitting ultrasound to the position depending on the detection information and controls the ultrasound device.

(23) The control device according to (22), wherein the position includes multiple positions, and wherein the control unit causes the ultrasound device to emit the ultrasound to the position that includes the multiple positions.

(24) The control device according to (22) or (23), wherein the control unit transmits a control signal for causing multiple ultrasound devices to emit the ultrasound to the position.

(25) The control device according to any one of (22) to (24), further comprising: a determination unit, wherein the determination unit determines at least an age, a gender, a hand movement, a line of sight, a fingerprint, a voice, or a facial expression of the object, based on the output of the sensor and records a result of determination in a recording device.

(26) The control device according to (25), further comprising: a determination unit, wherein the determination unit determines whether the object is a hand of a person and determines movement of the hand in a case where the object is the hand, and wherein the pattern-generating unit generates the tactile sensation pattern depending on a result of determination of the determination unit.

(27) The control device according to any one of (22) to (26), further comprising: a presentation-information-acquiring unit; and a position-identifying unit, wherein the presentation-information-acquiring unit acquires presentation information including an image, and wherein the position-identifying unit identifies the position, based on the presentation information.

(28) The control device according to (27), further comprising: a pattern-generating unit, wherein the pattern-generating unit generates a tactile sensation pattern, based on the presentation information, and wherein the control unit transmits the control signal depending on the tactile sensation pattern to the ultrasound device.

(29) A program for causing at least one computer to operate as the control device according to any one of (22) to (28).

(30) A system that presents texture comprising: an ultrasound device; and the control device according to any one of (22) to (28), wherein the ultrasound device is provided above a line of sight of a person to whom the ultrasound device presents the texture.

(31) A system that presents texture comprising: an ultrasound device; and the control device according to any one of (22) to (28), wherein the ultrasound device is provided in a space in which ultrasound energy that is generated by the ultrasound device is confined.

(32) The system according to (30) or (31), further comprising: a voice-presenting device that presents a voice to the person, wherein the voice-presenting device is an electronic device that includes an analog filter that shields ultrasound that is generated by the ultrasound device.

(33) The system according to any one of (30) to (32), further comprising: a photography device; and a display device, wherein the photography device photographs the person, and wherein the display device displays a result of photography performed by the photography device.

Of course, this is not a limitation.

Finally, the various embodiments of the present invention are described above, but these are described by way of example and do not limit the scope of the invention. The new embodiments can be carried out in various other aspects, various omissions, replacements, and modifications can be made without departing from the spirit of the invention. The embodiments and modifications thereto are included in the scope and the spirit of the invention and are included in a scope equivalent to that of the invention recited in claims.

1. An ultrasound device comprising:
a vibrating membrane; a tension-maintaining means; and multiple elements,
wherein the vibrating membrane is provided under tension,
wherein the tension-maintaining means supports the vibrating membrane and does not deform due to restoring force of the vibrating membrane, and
wherein the elements are periodically provided on the vibrating membrane, and each of the elements includes a first electrode and a second electrode,
wherein the first electrode is in contact with the vibrating membrane, and
wherein the second electrode faces the first electrode.

2. (canceled)

3. The ultrasound device according to claim 1,
wherein the tension-maintaining means includes an elastic body and maintains the tension that is applied to the vibrating membrane by using the elastic body.

4. (canceled)

5. The ultrasound device according to claim 1,
wherein the elements include a gas chamber in which gas is enclosed,
wherein the vibrating membrane forms a part of a wall portion of the gas chamber, and
wherein the second electrode has a through hole and is provided in the gas chamber.

6. The ultrasound device according to claim 5,
wherein a distance between a surface of the second electrode that does not face the first electrode and the wall portion of the gas chamber that faces the vibrating membrane is no less than one eighth and no more than three eighths of a wavelength at which the vibrating membrane resonates.

7. The ultrasound device according to claim 6,
wherein the distance is one fourth of the wavelength.

8. The ultrasound device according to claim 5,
wherein the gas chamber includes a flexible membrane, and
wherein the flexible membrane forms the part of the wall portion of the gas chamber, deforms depending on a difference in atmospheric pressure between locations inside and outside of the gas chamber, and reduces the difference in atmospheric pressure.

9. (canceled)

10. (canceled)

11. The ultrasound device according to claim 1,
wherein the elements have a vacuum space between the vibrating membrane and the second electrode.

12. The ultrasound device according to claim 1, further comprising:
a direct-current power supply,
wherein the direct-current power supply selectively applies a first voltage and a second voltage between the first electrode and the second electrode,
wherein the first voltage is a voltage equal to or more than a voltage at which the vibrating membrane adsorbs onto the second electrode, and
wherein the second voltage is a voltage less than the voltage at which the vibrating membrane adsorbs onto the second electrode.

13. The ultrasound device according to claim 12,
wherein the direct-current power supply selectively applies first potential and second potential to either the first electrode or the second electrode and selectively applies the first potential and third potential to the other of the first electrode and the second electrode,
wherein a difference between the first potential and the second potential is equal to the second voltage,
wherein a difference between the second potential and the third potential is equal to the second voltage, and
wherein a difference between the first potential and the third potential is equal to the first voltage.

14. The ultrasound device according to claim 12,
wherein the first electrode includes multiple electrodes, and longitudinal directions of the multiple electrodes are parallel with each other,
wherein the second electrode includes multiple electrodes, and longitudinal directions of the multiple electrodes are parallel with each other,
wherein a longitudinal direction of the first electrode and a longitudinal direction of the second electrode intersect with each other, and
wherein the elements are provided at a position at which the first electrode and the second electrode intersect with each other.

15. The ultrasound device according to claim 1, further comprising:
a reflection phase control unit,
wherein the reflection phase control unit controls a voltage that is applied between the first electrode and the second electrode such that the vibrating membrane at an element that reflects ultrasound emitted to the element at a first phase among the elements adsorbs onto the second electrode and controls the voltage that is applied between the first electrode and the second electrode such that the vibrating membrane at an element that reflects ultrasound emitted to the element at a second phase among the elements does not adsorb onto the second electrode.

16. The ultrasound device according to claim 15,
wherein the first phase is equal to a phase of the ultrasound emitted to the element, and
wherein the second phase is a phase into which the phase of the ultrasound emitted to the element is inverted.

17. (canceled)

18. The ultrasound device according to claim 1, an alternating-current power supply,
wherein the alternating-current power supply applies a voltage at a predetermined frequency between the first electrode and the second electrode, and wherein the elements emit ultrasound depending on the predetermined frequency,
wherein the alternating-current power supply includes a first alternating-current power supply and a second alternating-current power supply,
wherein the second alternating-current power supply outputs a voltage that has a phase into which a phase of a voltage that is outputted by the first alternating-current power supply is inverted, and
wherein the first alternating-current power supply and the second alternating-current power supply apply the voltage at the predetermined frequency between the first electrodes and the second electrodes of the respective different elements.

19. The ultrasound device according to claim 1, further comprising:
an alternating-current power supply and an emission control unit,
wherein the alternating-current power supply applies a voltage at a predetermined frequency between the first electrode and the second electrode, and wherein the elements emit ultrasound depending on the predetermined frequency,
wherein the emission control unit controls a direct voltage that is applied between the first electrode and the second electrode such that the vibrating membrane at an element that emits the ultrasound among the elements does not adsorb onto the second electrode and controls the direct voltage that is applied between the first electrode and the second electrode such that the vibrating membrane at an element that does not emit the ultrasound among the elements adsorbs onto the second electrode.

20. An ultrasound device comprising:
an element; and a reflection phase control unit,
wherein the element includes a vibrating membrane, a first electrode, and a second electrode,
wherein the vibrating membrane is under tension,
wherein the first electrode is in contact with the vibrating membrane,
wherein the second electrode faces the first electrode, and
wherein the reflection phase control unit controls a voltage that is applied between the first electrode and the second electrode such that the vibrating membrane adsorbs onto the second electrode in a case where ultrasound emitted to the element is reflected at a first phase and controls the voltage that is applied between the first electrode and the second electrode such that the vibrating membrane does not adsorb onto the second electrode in a case where the ultrasound emitted to the element is reflected at a second phase.

21. The ultrasound device according to claim 20,
wherein the first phase is equal to a phase of the ultrasound emitted to the element, and
wherein the second phase is a phase into which the phase of the ultrasound emitted to the element is inverted.

22. A control device that controls an ultrasound device, the control device comprising:
a detection-information-acquiring unit and a control unit,
wherein the detection-information-acquiring unit acquires, as detection information, an output of a sensor that detects presence of an object at a predetermined position, and
wherein the control unit transmits, to the ultrasound device, a control signal for emitting ultrasound to the position depending on the detection information and controls the ultrasound device.

23. (canceled)

24. (canceled)

25. (canceled)

26. (canceled)

27. (canceled)

28. (canceled)

29. A non-transitory computer-readable memory medium storing a program for causing at least one computer to operate as the control device according to claim 22.

30. A system that presents texture comprising:
an ultrasound device; and the control device according to claim 22,
wherein the ultrasound device is provided above a line of sight of a person to whom the ultrasound device presents the texture.

31. (canceled)

32. The system according to claim 30, further comprising:
a voice-presenting device that presents a voice to the person,
wherein the voice-presenting device is an electronic device that includes an analog filter that shields ultrasound that is generated by the ultrasound device.

33. (canceled)
